(19) United States
(12) Patent Application Publication
(10) Pub. No.: US 2026/0171322 A1
(43) Pub. Date: Jun. 18, 2026

(54) CERAMIC ELECTRONIC COMPONENT

(71) Applicant: Murata Manufacturing Co., Ltd., Nagaokakyo-shi (JP)

(72) Inventors: Yosuke MATSUSHITA, Nagaokakyo-shi (JP); Takehito TAGUCHI, Nagaokakyo-shi (JP); Masashi ARAI, Nagaokakyo-shi (JP); Makoto TAKADA, Nagaokakyo-shi (JP)

(73) Assignee: Murata Manufacturing Co., Ltd., Nagaokakyo-shi (JP)

(21) Appl. No.: 19/463,175

(22) Filed: Jan. 29, 2026

Related U.S. Application Data
(63) Continuation of application No. PCT/JP2024/021010, filed on Jun. 10, 2024.

(30) Foreign Application Priority Data
Jul. 31, 2023 (JP) 2023-124773

(51) Int. Cl. H01G 4/30; H01G 4/224

(52) U.S. Cl. CPC H01G 4/30; H01G 4/224

(57) ABSTRACT

A ceramic electronic component includes a multilayer body having a first surface, a pad electrode on the first surface, and a protective film arranged surrounding the pad electrode and straddling an outer edge portion of the pad electrode and the first surface. Relative to a reference defined by a flat portion of the first surface, an outer edge portion of the protective film is depressed below the reference plane. A surface of at least a central portion of the pad electrode not covered with the protective film projects above the reference plane.

### CROSS-REFERENCE TO RELATED APPLICATIONS

This application is a continuation of PCT/JP2024/021010, filed Jun. 10, 2024, which claims priority to Japanese Patent Application No. 2023-124773, filed Jul. 31, 2023. The entire contents of these priority documents are incorporated herein by reference.

### TECHNICAL FIELD

The present disclosure relates to a ceramic electronic component.

### BACKGROUND ART

Japanese Patent Laid-Open No. 2002-231860 (PTL 1) describes a configuration in which a conductor land is arranged on a surface of a ceramic substrate. The conductor land includes a base conductor film. A glass layer is arranged so as to surround the outer periphery of the base conductor film. The glass layer is arranged so as to straddle a portion near the outer periphery of the base conductor film and the surface of the ceramic substrate. A Ni plating layer is arranged so as to cover the base conductor film. An Au plating layer is arranged so as to cover the Ni plating layer.

According to PTL 1, this configuration enables it to prevent the phenomenon in which an end portion of the base conductor film is pulled and turned up even when stress is caused in the Ni plating layer.

### CITATION LIST

### Patent Literature

PTL 1: Japanese Patent Laid-Open No. 2002-231860

### SUMMARY

A ceramic electronic component based on the present disclosure includes a multilayer body having a first surface, a pad electrode arranged on the first surface, and a protective film arranged so as to surround the pad electrode while arranged so as to straddle an outer edge portion of the pad electrode and the first surface. When a virtual plane serving as a reference of the first surface is defined as a reference plane, an outer edge portion of the protective film is depressed relative to the reference plane, and a surface of at least a central portion of a portion included in the pad electrode and not covered with the protective film is projecting relative to the reference plane.

### BRIEF DESCRIPTION OF DRAWINGS

FIG. 1 is a partially enlarged cross-sectional view of a ceramic electronic component according to a first embodiment.

FIG. 2 is a drawing obtained by adding a reference plane to FIG. 1.

FIG. 3 is a partially enlarged cross-sectional view of a ceramic electronic component according to a second embodiment.

FIG. 4 is a drawing obtained by adding a reference plane to FIG. 3.

FIG. 5 is a partially enlarged cross-sectional view of the ceramic electronic component according to a variation of the second embodiment.

FIG. 6 is a partially enlarged cross-sectional view of a ceramic electronic component according to a third embodiment.

FIG. 7 is a partially enlarged cross-sectional view of the ceramic electronic component according to the third embodiment.

### DESCRIPTION OF EMBODIMENTS

The drawings are not necessarily to scale and certain dimensions may be exaggerated for clarity. A concept up or upper or down or lower mentioned in the description below does not mean absolute up or upper or down or lower but may mean relative up or upper or down or lower in terms of a shown position.

In the above-described configuration, the conductor land is projecting from the surface of the ceramic substrate. The inventors have recognized that, when an impact is applied to the conductor land, a crack may occur from the interface between the glass layer and the ceramic substrate at an outer peripheral end of the glass layer, which serves as a starting point. When the crack progresses, a crack may be caused in the interface between the base conductive film and the ceramic substrate from the outer periphery of the base conductive film toward the inner side.

Thus, the present disclosure is directed to providing a ceramic electronic component in which occurrence of a crack between a pad electrode and a multilayer body is hindered even when an impact is applied.

As described in detail below, since an outer edge portion of the protective film is depressed relative to the reference plane, an interface serving as the starting point of a crack is situated in a position that is set back from the reference plane. Thus, a situation in which an impact is applied to the interface can be avoided easily and as a result, a ceramic electronic component in which occurrence of a crack between a pad electrode and a multilayer body is hindered may be realized even when an impact is applied.

### First Embodiment

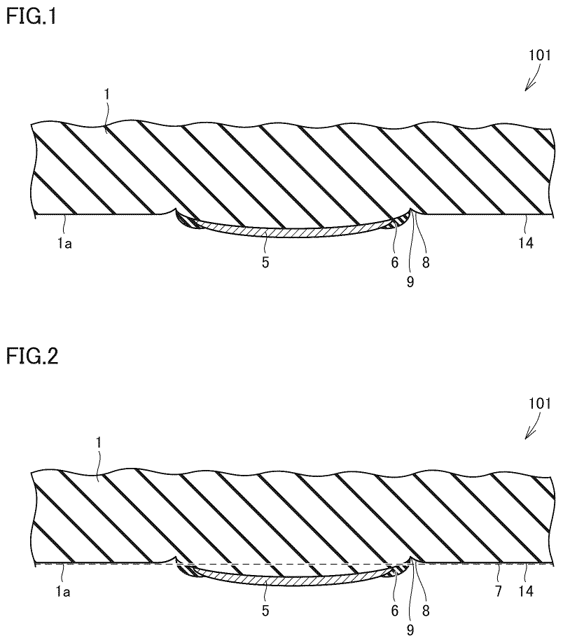

A ceramic electronic component according to a first embodiment is described with reference to FIGS. 1 and 2. FIG. 1 illustrates the ceramic electronic component according to the present embodiment. A multilayer body 1 includes a terminal portion as illustrated. FIG. 1 shows one terminal portion of multilayer body 1 and its vicinity through enlargement. This applies to the other drawings that follow, similarly.

Ceramic electronic component 101 includes multilayer body 1 having a first surface 1a, a pad electrode 5 arranged on first surface 1a, and a protective film 6 (which may also be referred to herein as a glass layer) arranged so as to surround pad electrode 5 while arranged so as to straddle an outer edge portion of pad electrode 5 and first surface 1a. Multilayer body 1 is formed by stacking a plurality of ceramic layers. Multilayer body 1 is formed, for example, by stacking a plurality of ceramic green sheets and pressing the sheets, and then performing sintering thereon to integrate the sheets. Wiring connected to pad electrode 5 may be arranged inside multilayer body 1. First surface 1a represents the entire so-called mounting surface of multilayer body 1. In FIG. 1, first surface 1a is the entire lower surface of multilayer body 1. First surface 1a includes a flat wide portion and a depressed portion, and in these, a geometric plane assumed to be at the height of the flat wide portion is a reference plane 7 illustrated in FIG. 2. In FIG. 2, reference plane 7 is indicated by a dashed line. FIG. 2 is obtained by adding reference plane 7 to FIG. 1.

When the virtual plane, which serves as a reference of first surface 1a, is defined as reference plane 7, an outer edge portion of protective film 6 is depressed relative to reference plane 7. A surface of at least a central portion of a portion included in pad electrode 5 and not covered with protective film 6 is projecting relative to reference plane 7. A combination of pad electrode 5 and protective film 6 may be referred to as the “terminal portion”. When ceramic electronic component 101 is mounted over another object, electrical connection is performed via the terminal portion.

First surface 1a includes a bottom portion 9, an inclined surface 8, and a flat portion 14. Ceramic electronic component 101 includes bottom portion 9, which is a depression, in an outer peripheral portion of the terminal portion. Flat portion 14 is a portion that is flat and extends at the height of reference plane 7. Inclined surface 8 is situated between bottom portion 9 and flat portion 14. Inclined surface 8 is not limited to a flat surface but may be a curved surface.

The configuration described in the present embodiment can be attained by, for example, a method in which pad electrode 5 is formed on first surface 1a and protective film 6 is further formed so as to straddle the outer edge portion of pad electrode 5 and first surface 1a, and then pressing is performed on this first surface 1a using a plate having a slight cushioning property. Accordingly, the configuration is brought where the outer edge portion of protective film 6 is depressed relative to reference plane 7.

Since in the present embodiment, the outer edge portion of protective film 6 is depressed relative to reference plane 7, a portion serving as the starting point of a crack, that is, the interface between protective film 6 and multilayer body 1 is situated in a position that is set back from reference plane 7. Thus, it is facilitated to avoid a situation in which an impact is applied to the interface. As a result, a ceramic electronic component in which occurrence of a crack between a pad electrode and a multilayer body is hindered even when an impact is applied may be realized. In other words, by setting the interface (the potential starting point for cracks) back into a depression, the component avoids direct impact at the most vulnerable structural point, thereby hindering crack propagation.

In addition, since in the present embodiment, the outer edge portion of protective film 6 is depressed relative to reference plane 7, the amount of the projection of the entire terminal portion can be curbed and it is also advantageous for reduction in height.

As shown in the present embodiment, it is preferable that inclined surface 8 forming part of the surface of multilayer body 1 is provided outside the outer edge portion of protective film 6, and when viewed in a direction perpendicular to first surface 1a, protective film 6 and inclined surface 8 are in contact with each other, and that inclined surface 8 links bottom portion 9 of first surface 1a, which is depressed together with the outer edge portion of protective film 6, and flat portion 14 of first surface 1a, which lies at the height of reference plane 7. By adopting this configuration, it is enabled to smoothly connect flat portion 14 lying at the height of reference plane 7 and bottom portion 9 being a depression.

### Second Embodiment

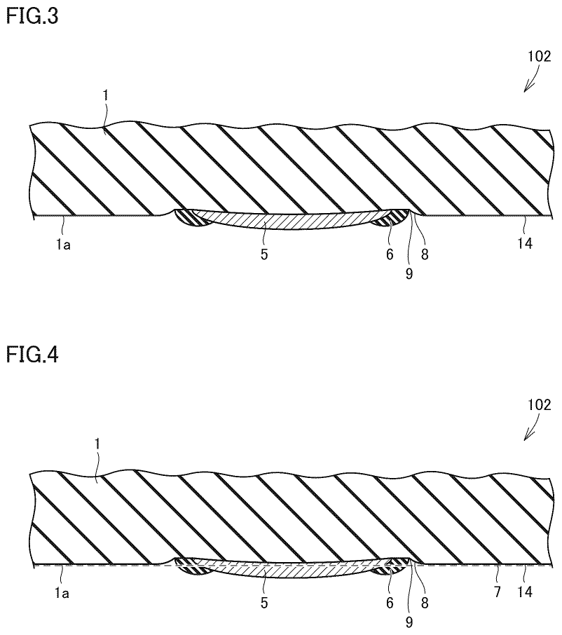

A ceramic electronic component according to a second embodiment based is described with reference to FIGS. 3 and 4. FIG. 3 illustrates the ceramic electronic component according to the present embodiment. FIG. 4 is obtained by adding a reference plane 7 to FIG. 3.

The basic configuration of ceramic electronic component 102 is the same as that described in the first embodiment, but further includes the following configuration. In ceramic electronic component 102, an outer edge portion of a pad electrode 5 is depressed relative to reference plane 7.

In the present embodiment, the outer edge portion of pad electrode 5 is depressed relative to reference plane 7, and application of an impact to the outer edge portion of pad electrode 5, which can serve as the starting point of a crack, is hindered accordingly. As a result, it is enabled to attain a ceramic electronic component in which occurrence of a crack between a pad electrode and a multilayer body is hindered even when an impact is applied.

Since in the present embodiment, the outer edge portion of pad electrode 5 is depressed relative to reference plane 7, the amount of the projection of the entire terminal portion can be curbed and it is further advantageous for reduction in height.

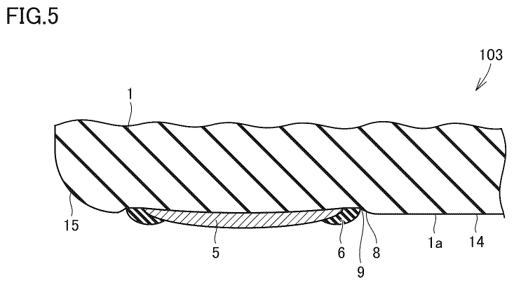

Barrel polishing may be performed on the entire multilayer body 1 for chamfering. When the terminal portion is positioned near an end of a first surface 1a, a ceramic electronic component 103 illustrated in FIG. 5 can result from the barrel polishing. In ceramic electronic component 103, a chamfered portion 15 formed by the barrel polishing and an inclined surface 8 are in contact with each other. Outside inclined surface 8, a flat portion 14 is not necessarily present so as to surround the entire periphery. When chamfered portion 15 is formed as in ceramic electronic component 103 illustrated as an example in FIG. 5, flat portion 14 may be adjacent to part of the periphery of inclined surface 8, and instead of flat portion 14, chamfered portion 15 may be adjacent to another part of the periphery of inclined surface 8.

Although a configuration in which chamfered portion 15 formed by barrel polishing and inclined surface 8 are in contact with each other is presented here on the basis of ceramic electronic component 102 described in the second embodiment, this is merely an example. The configuration is not limited to this but, for example, may be the configuration based on ceramic electronic component 101 described in the first embodiment, in which chamfered portion 15 formed by barrel polishing and inclined surface 8 are in contact with each other.

### Third Embodiment

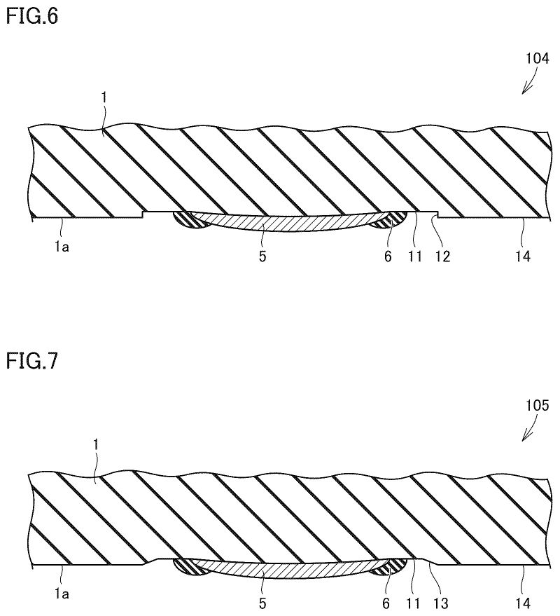

A ceramic electronic component according to a third embodiment is described with reference to FIG. 6. FIG. 6 illustrates the ceramic electronic component according to the present embodiment.

The basic configuration of ceramic electronic component 104 is the same as that described in the first embodiment, but further includes the following configuration. In ceramic electronic component 104, a flat surface 11 extends outward from a portion where an outer edge portion of a protective film 6 is depressed relative to a reference plane 7. Flat surface 11 is set back from reference plane 7. A step 12 is situated between flat surface 11 and a flat portion 14 lying at the height of reference plane 7.

Also in the present embodiment, effects similar to those described in the first embodiment can be obtained.

Furthermore, as a variation of the present embodiment, the configuration may be like a ceramic electronic component 105 illustrated in FIG. 7. Also in ceramic electronic component 105, flat surface 11 extends outward from a portion where the outer edge portion of protective film 6 is depressed relative to reference plane 7. Flat surface 11 is set back from reference plane 7. An inclined surface 13 is situated between flat surface 11 and flat portion 14 lying at the height of reference plane 7. Even with such a configuration, effects similar to those described in the first embodiment can be obtained.

Two or more of the above-described embodiments may be appropriately combined and employed.

The herein-disclosed foregoing embodiments are presented by way of illustration and example in all respects and are not to be taken by way of limitation. The scope of the present invention is defined by the claims and encompasses all changes within the purport and scope equivalent to the claims.

### REFERENCE SIGNS LIST

1 multilayer body; 1a first surface; 5 pad electrode; 6 protective film; 7 reference plane; 8, 13 inclined surface; 9 bottom portion; 11 flat surface; 12 step; 14 flat portion; 15 chamfered portion; 101, 102, 103, 104, 105 ceramic electronic component.

1. A ceramic electronic component comprising:
a multilayer body having a first surface;
a pad electrode on the first surface; and
a protective film surrounding the pad electrode and straddling an outer edge portion of the pad electrode and the first surface, wherein
relative to a reference plane defined by a flat portion of the first surface,
an outer edge portion of the protective film is depressed below the reference plane, and a surface of at least a central portion of a portion of the pad electrode not covered with the protective film projects above the reference plane.

2. The ceramic electronic component according to claim 1, wherein the outer edge portion of the pad electrode is below to the reference plane.

3. The ceramic electronic component according to claim 1, wherein the first surface includes an inclined surface outside the outer edge portion of the protective film.

4. The ceramic electronic component according to claim 3, wherein the inclined surface is in contact with the protective film when viewed in a direction perpendicular to the first surface.

5. The ceramic electronic component according to claim 3, wherein
the inclined surface connects a bottom portion a depression in the first surface to the flat portion of the first surface.

6. The ceramic electronic component according to claim 5, wherein the outer edge portion of the protective film is within the bottom portion.

7. The ceramic electronic component according to claim 1, wherein the multilayer body includes a plurality of sintered ceramic layers integrated with one another.

8. The ceramic electronic component according to claim 1, further comprising internal wiring disposed within the multilayer body and electrically connected to the pad electrode.

9. The ceramic electronic component according to claim 1, wherein the first surface includes a chamfered portion at a peripheral edge of the multilayer body.

10. The ceramic electronic component according to claim 9, wherein the chamfered portion is in contact with the inclined surface.

11. A ceramic electronic component comprising:
a multilayer body having a first surface;
a pad electrode on the first surface; and
a protective film straddling an outer edge of the pad electrode and the first surface,
wherein the first surface includes a flat surface set back from a reference plane, and a step situated between the flat surface and a flat portion of the first surface lying at the height of the reference plane, and
an outer edge of the protective film is situated on the flat surface.

12. The ceramic electronic component according to claim 11, wherein the step includes an inclined surface.

13. The ceramic electronic component according to claim 11, wherein the protective film completely surrounds an outer periphery of the pad electrode.

14. The ceramic electronic component according to claim 11, wherein a surface of a central portion of the pad electrode is at a higher elevation than the protective film.

15. The ceramic electronic component according to claim 11, wherein the multilayer body includes a mounting surface, and the first surface is the mounting surface.

16. The ceramic electronic component according to claim 11, wherein the pad electrode and the protective film together form a terminal portion.

17. A ceramic electronic component comprising:
a multilayer body;
a terminal portion on a mounting surface of the multilayer body, the terminal portion including a pad electrode and a protective film covering a periphery of the pad electrode;
wherein an outer edge of the protective film is recessed into a depression formed in the mounting surface such that an interface between the protective film and the multilayer body is set back from a virtual plane defined by the mounting surface; and
a central surface of the pad electrode projects outwardly beyond the virtual plane.

18. The ceramic electronic component according to claim 17, wherein the pad electrode is partially recessed into the depression.

19. The ceramic electronic component according to claim 17, wherein the depression includes a bottom portion and an inclined surface extending from the bottom portion to the mounting surface.

20. The ceramic electronic component according to claim 17, wherein the protective film includes a glass layer.
